(19) United States
(12) Patent Application Publication
(10) Pub. No.: US 2008/0257176 A1
(43) Pub. Date: Oct. 23, 2008

(54) Compressible Trash Container

(76) Inventor: Jung-Yi CHIU, Taipei (TW)

Correspondence Address: Richard Chen, 7F., No. 122 Sung Chiang Rd., Taipei, TW

(21) Appl. No.: 11/738,453

(22) Filed: Apr. 20, 2007

(51) Int. Cl. B30B 15/02

(52) U.S. Cl. 100/221

(57) ABSTRACT

The invention is to provide a compressible trash container that is mainly composed of a top cover and a cylinder. Inside the top cover there is a moveable base that connects to the top cover by several elastic pulleys. External force applied to the top cover presses the moveable base down to compress the trash. It will be back to its original position after the force is removed. In this way, extra storage space can be obtained by effective reduction of trash volume.

### BACKGROUND OF THE INVENTION

1. Field of the Invention

The invention is related to trash container structure, especially for a compressible trash container that is simple to use, so wastes can be compressed to reduce volume and extra storage space is provided.

2. Description of the Prior Art

In our everyday life, trash and wastes are generated any time and any place. People use trash containers to keep office waste papers and home garbage temporarily and maintain a tidy environment. However, most trash containers have a fixed volume and limited capacity. Once they are full, they need to be emptied. In such a way repeatedly, it could waste a lot of time and efforts, which is not economical. Some people try to get extra space by using hands to press the trash down. But this is not hygienic and could overturn the container and scatter the trash.

The inventor was eager to seek a solution and finally designed a compressible trash container that meets the requirements in both usability and environmental protection.

### SUMMARY OF THE INVENTION

The main objective for the invention is to provide an innovative compressible trash container that is easy to use and able to generate extra storage space by reducing trash volume.

To achieve the objective, the structure for the compressible trash container is mainly composed of a top cover and a cylinder. On the periphery of the top cover there is a hinge that connects to the cylinder and is able to open and close. At the bottom of the outer side of the cylinder there is a paddle and a connecting rod that connects to the top cover, so users can control the opening and closing for the top cover by using the foot paddle. Particularly, the center of the top cover surface has a round hole inside which there is a moveable base. On the proper location of the periphery of the round hole there are at least three pulleys at equal distance. Through a strap tying the periphery of the moveable base, the top edge of the moveable base fits into the round hole. Thus, reciprocal and vertical movement of the moveable base is able to compress the trash for extra storage space.

The following provides practical embodiments with detailed description and illustration for the patent examiners to further understand the functions and features for the invention.

### BRIEF DESCRIPTION OF THE DRAWINGS

FIG. 1 is a disassembly diagram for a preferred embodiment for the compressible trash container in the invention.

FIG. 2 is an exterior diagram for a preferred embodiment for the compressible trash container in the invention.

FIG. 3 is an illustration for the use of a preferred embodiment for the compressible trash container in the invention.

FIG. 4 is an exterior diagram for another preferred embodiment for the compressible trash container in the invention.

FIG. 5 is an illustration of the compression mechanism for another a preferred embodiment for the compressible trash container in the invention.

### DETAILED DESCRIPTION OF THE PREFERRED EMBODIMENT

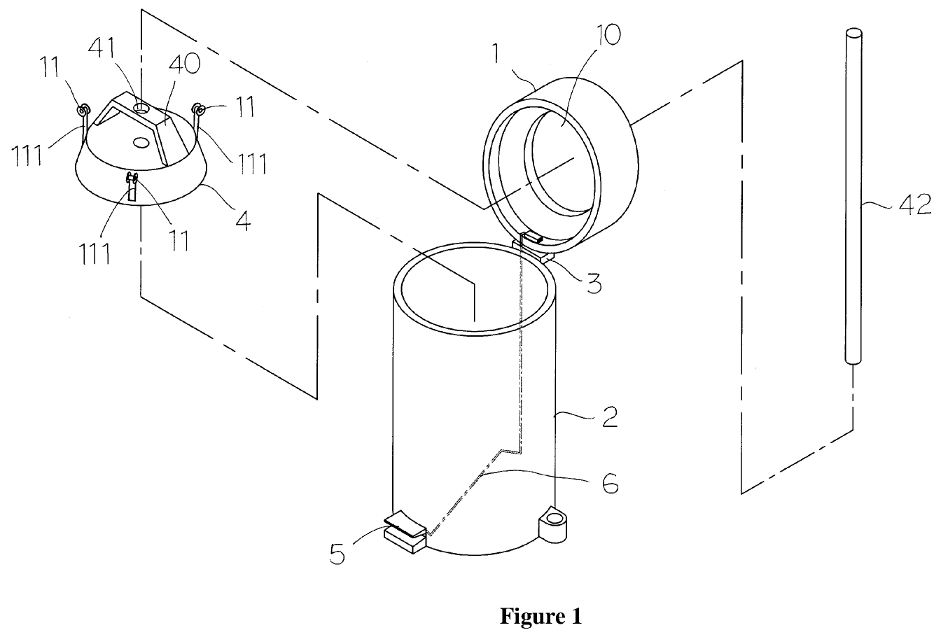

Please refer to FIG. 1 for the disassembly diagram for a preferred embodiment of the compressible trash container. Its structure is mainly composed of a top cover (1) and cylinder (2). On the periphery of the top cover (1) and the corresponding outer side of the cylinder (2) there is a connecting hinge (3), so the top cover (1) is able to open and close through the connection mechanism of the hinge (3). On the periphery of the bottom of the cylinder (2) there is a paddle (5) at a proper location. Along the bottom and the surrounding wall of the cylinder (2) there is a rod (6) connecting and supporting the above-mentioned hinge (3) and simultaneously moving the top cover (1). Thus, when the user presses the paddle (5), it will activate the movement of the connecting rod (6) and further to push the top cover (1) open. In this way, the objective for using foot paddle to control the opening and closing for the top cover (1) can be achieved.

The features for the invention are described in the following. In the center of the top cover (1) surface there is a round hole (10) accommodating a moveable base (4) and an arch-like handle (40) with a through-hole (41). The through-hole (41) is for a rod (42) to pass through and attach to the moveable base (4). On the proper location of the periphery of the round hole (10) there are at least three pulleys (11) at equal distance. Through a strap (111) tying the periphery of the moveable base (4), the top edge of the moveable base (4) fits into the round hole (10).

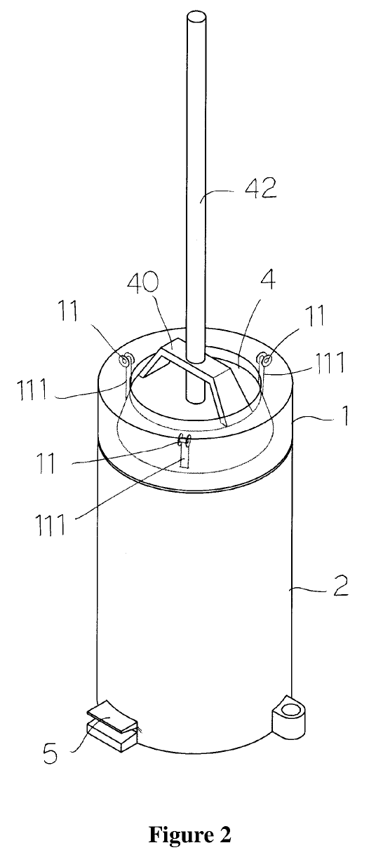

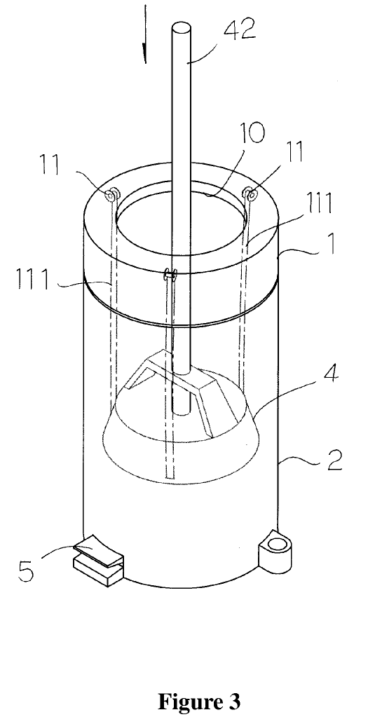

Please refer to FIG. 2 and FIG. 3. When the compressible trash container with the above-mentioned structure is in use, the user presses the foot paddle (5) and activates the connecting rod (6) to push the hinge (3) and open the top cover (1). Then the user can easily put trash into the container. When the foot is off the paddle (5), the top cover (1) will close automatically. When the cylinder (2) has a certain amount of accumulated trash and cannot store more, the user can hand-grasp the rod (42) and push it down repeatedly. This will generates extra storage space through vertical movement of the moveable base (4) to compress the trash.

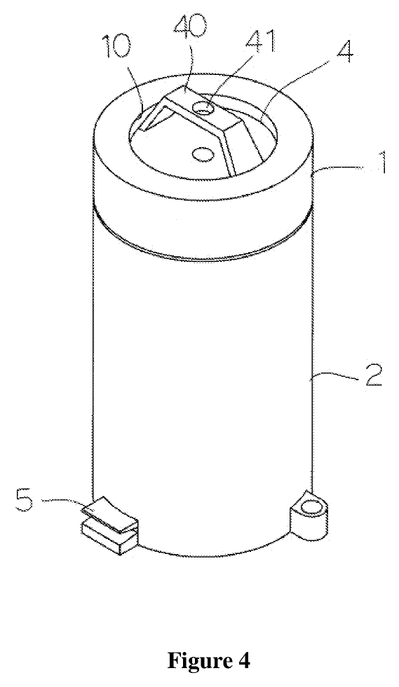

Please further refer to FIG. 4. The compressible trash container in this invention is also suitable for individual office to dispose small size trash. Its structure will be similar to the above-mentioned, including a top cover (1) and a cylinder (2). In the center of the top cover (1) surface there is a round hole (10) accommodating a moveable base (4) and an arch-like handle (40) with a through-hole (41). On the proper location of the periphery of the round hole (10) there are at least three pulleys (12) at equal distance. Through a strap (121) tying the periphery of the moveable base (4), the top edge of the moveable base (4) fits into the round hole (10). The only difference is there is no rod (42).

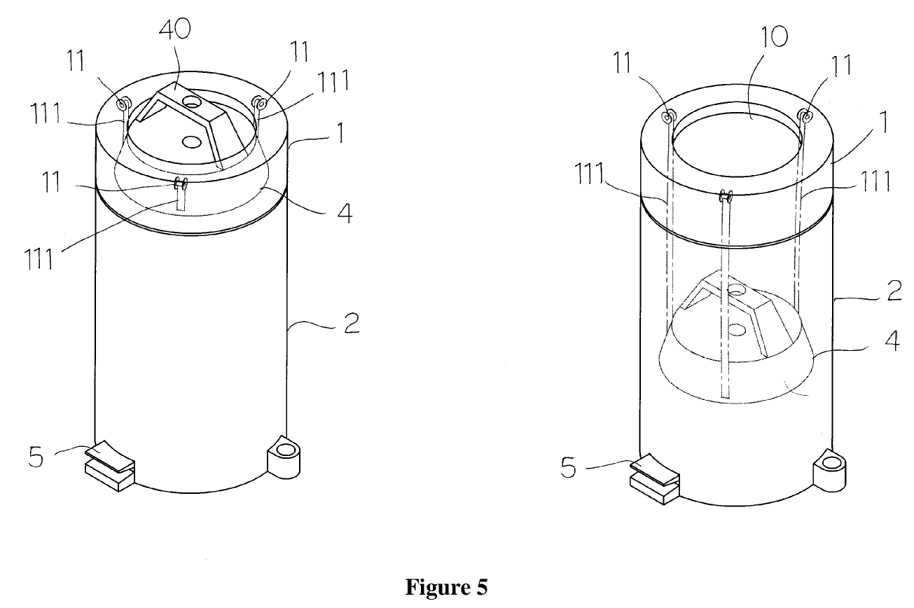

Please refer to FIG. 5. When the compressible trash container is in use, the user presses the foot paddle (5) to open the top cover (1), and then put the trash in. When the foot is off the paddle (5), the top cover (1) will automatically close to complete the trash disposal action. When the cylinder (2) has a certain amount of accumulated trash and cannot store anymore, the user can hand-grasp the handle (40) on the moveable base (4) and push it down repeatedly. This will generates extra storage by compressing the trash in an effective manner.

In summary, this invention is actually an innovative product that was not found in its similar products or publications. It shall meet the requirements for patent application. However, the above-mentioned example is merely an preferred embodiment. Hereafter, it is made clear that those variations adopting the structure in this invention and illustration to produce the equivalent effect shall be covered in the claims by the invention

What is claimed is:

1. A compressible trash container is mainly composed of a top cover and a cylinder, which are connected by a hinge; at the bottom of the outer side of the cylinder there is a paddle; along the bottom of the cylinder and its wall, there is a connecting rod that connects and supports the above-mentioned hinge, so it can simultaneously move the top cover; it's features are described as in the following:
in the center of the top cover surface there is a round hole to accommodate a moveable base; on the proper location of the periphery of the round hole there are at least three pulleys at equal distance; through a strap tying the periphery of the moveable base, the top edge of the moveable base fits into the round hole.

2. As described in claim 1 for a compressible trash container, there is a arch-like handle with a through-hole on the surface of the moveable base.

3. As described in claim 1 for a compressible trash container, the moveable base has a rod to pass through a through-hole to make one integrated unit.
